(19) United States
(12) Patent Application Publication
(10) Pub. No.: US 2024/0251017 A1
(43) Pub. Date: Jul. 25, 2024

(54) SYSTEM AND METHOD FOR PROVIDING CONNECTIVITY BETWEEN A PROXY CLIENT AND TARGET RESOURCES USING A TRANSPORT SERVICE

(71) Applicant: VMWARE, INC., Palo Alto, CA (US)

(72) Inventors: David Mark William Byard, San Jose, CA (US); Benjamin Duong, Medford, MA (US); Praagyan Pokharel, Medford, MA (US)

(21) Appl. No.: 18/101,542

(22) Filed: Jan. 25, 2023

(51) Int. Cl. H04L 67/2871; H04L 41/40; H04L 67/10

(52) U.S. Cl. CPC H04L 67/2871; H04L 41/40; H04L 67/10

(57) ABSTRACT

System and computer-implemented method for connecting a proxy client to a transport client through a transport service with a plurality of stateless transport server nodes in a distributed computing system uses a command channel established from the transport client to a first transport server node in the transport service. A second transport server node in the transport service is selected for a connection request from the proxy client. The first transport server node is connected from the second transport server node when the second transport server node is not the first transport server node with the command channel so that connectivity between the proxy client and the transport client is established through the first transport server node and the second transport server node.

### BACKGROUND

Software-defined data center (SDDC) is an architectural approach based on virtualization and automation, which drives many of current leading data centers. In an SDDC, the infrastructure is virtualized, and the control of the SDDC is entirely automated by software. In some implementations, a cloud-based service may provide management and/or support for the SDDC. Thus, in a computing environment with one or more SDDCs, such as a private, public or multiple (e.g., hybrid) cloud environment, there may be a need to establish a connection to the SDDCs from the cloud-based service using a transport service, which provides the necessary connections between the cloud-based service and the SDDCs.

However, a conventional transport service may not provide an efficient solution for the cloud-based service to access the SDDCs, especially if the transport service is running in a Kubernetes environment, which may limit using certain technologies for connectivity between the cloud-based service and the SDDCs.

### SUMMARY

System and computer-implemented method for connecting a proxy client to a transport client through a transport service with a plurality of stateless transport server nodes in a distributed computing system uses a command channel established from the transport client to a first transport server node in the transport service. A second transport server node in the transport service is selected for a connection request from the proxy client. The first transport server node is connected from the second transport server node when the second transport server node is not the first transport server node with the command channel so that connectivity between the proxy client and the transport client is established through the first transport server node and the second transport server node.

A computer-implemented method for connecting a proxy client to a transport client through a transport service with a plurality of stateless transport server nodes in a distributed computing system in accordance with an embodiment of the invention comprises establishing a command channel from the transport client to a first transport server node among the stateless transport server nodes in the transport service, receiving a connection request from the proxy client at the transport service, selecting a second transport server node from the stateless transport server nodes in the transport service for the connection request, and when the second transport server node is not the first transport server node with the command channel to the transport client, connecting to the first transport server node from the second transport server so that connectivity between the proxy client and the transport client is established through the first transport server node and the second transport server node. In some embodiments, the steps of this method are performed when program instructions contained in a computer-readable storage medium are executed by one or more processors.

A system in accordance with an embodiment of the invention comprises memory and at least one processor configured to establish a command channel from a transport client to a first transport server node among stateless transport server nodes in a transport service, receive a connection request from a proxy client at the transport service, select a second transport server node from the stateless transport server nodes in the transport service for the connection request, and when the second transport server node is not the first transport server node with the command channel to the transport client, connect to the first transport server node from the second transport server so that connectivity between the proxy client and the transport client is established through the first transport server node and the second transport server node.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a distributed computing system with a cloud-based service, a transport service and a number of software-defined data centers (SDDCs) in accordance with an embodiment of the invention.

FIG. 2 is a diagram of an SDDC that can be deployed in the distributed computing system in accordance with an embodiment of the invention.

FIG. 3 is a process flow diagram of a process of establishing a connection between the cloud-based service and a target resource in one of the SDDCs in the distributed computing system in accordance with an embodiment of the invention.

FIG. 4 shows substeps of a step of the process flow diagram where a transport client running in the target SDDC connects to a transport server node in the transport service in accordance with an embodiment of the invention.

FIG. 5 shows substeps of a step of the process flow diagram where a proxy client, i.e., the cloud-based service, connects to a transport server node to connect to the command channel in accordance with an embodiment of the invention.

FIG. 6 shows the substeps of a step of the process flow diagram where a particular transport server node in the transport service requests a data channel connection from the transport client in the target SDDC in accordance with an embodiment of the invention.

FIG. 7 shows the substeps of a step of the process flow diagram where the transport client in the target SDDC opens a data channel to the particular transport server node in accordance with an embodiment of the invention.

FIGS. 8A-8D illustrate the steps of the process flow diagram shown in FIG. 3 using an example in accordance with an embodiment of the invention.

FIG. 9 is a flow diagram of a computer-implemented method for connecting a proxy client to a transport client through a transport service with a plurality of stateless transport server nodes in a distributed computing system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

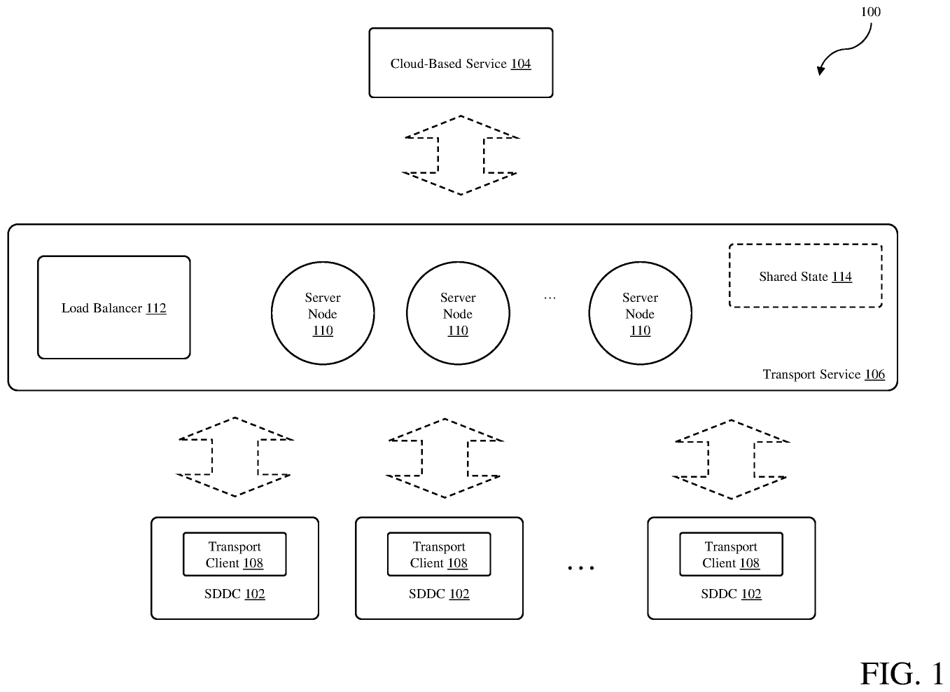

Turning now to FIG. 1, a distributed computing system 100 in accordance with an embodiment of the invention is illustrated. The distributed computing system 100 includes a plurality of software-defined data centers (SDDCs) 102, a cloud-based service 104 and a transport service 106. As described in detail below, communication connections are made between the cloud-based service 104 and the SDDCs 102 via the transport service 106 so that the cloud-based service can communicate with any of the SDDCs for various operations. In an embodiment, the SDDCs 102 are orchestrated and managed by the cloud-based service 104, and thus, the communication connections are used by the cloud-based service to access the SDDCs to execute orchestration and management operations.

Each SDDC 102 in the distributed computing system 100 may be running in an on-premise computing environment (sometimes referred to herein as a private cloud computing environment or simply a private cloud), in a public cloud computing environment (or simply a public cloud) or in a hybrid cloud (a combination of private and public clouds). These SDDCs 102 may be owned and operated by different business entities, such as business enterprises. As shown in FIG. 1, each of the SDDCs 102 includes a transport client 108, as well as other components (not shown in FIG. 1), which enables connectivity with the cloud-based service 104 via the transport service 106 so that the cloud-based service can communicate with a target resource in the SDDC 200. The transport client 108 in each of the SDDCs will be described in more detail below.

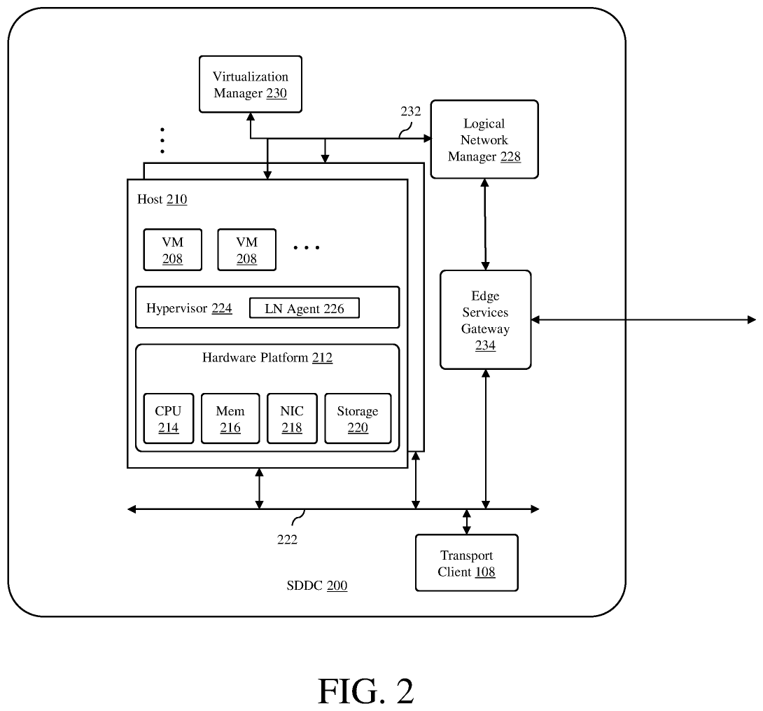

Turning now to FIG. 2, a representative SDDC 200 that can be deployed in the distributed computing system 100 in accordance with an embodiment of the invention is illustrated. Thus, the SDDC 200 is an example of the SDDCs 102 depicted in FIG. 1. As shown in FIG. 2, the SDDC 200 includes one or more host computer systems (“hosts”) 210. The hosts may be constructed on a server grade hardware platform 212, such as an x86 architecture platform. As shown, the hardware platform of each host may include conventional components of a computing device, such as one or more processors (e.g., CPUs) 214, system memory 216, a network interface 218, and storage 220. The processor 214 can be any type of a processor commonly used in servers. The memory 216 is volatile memory used for retrieving programs and processing data. The memory 216 may include, for example, one or more random access memory (RAM) modules. The network interface 218 enables the host 210 to communicate with other devices that are inside or outside of the SDDC 200 via a communication medium, such as a network 222. The network interface 218 may be one or more network adapters, also referred to as network interface cards (NICs). The storage 220 represents one or more local storage devices (e.g., one or more hard disks, flash memory modules, solid state disks and/or optical disks), which may be used to form a virtual storage area network (SAN).

Each host 210 may be configured to provide a virtualization layer that abstracts processor, memory, storage and networking resources of the hardware platform 212 into virtual computing instances, e.g., virtual machines 208, that run concurrently on the same host. The virtual machines run on top of a software interface layer, which is referred to herein as a hypervisor 224, that enables sharing of the hardware resources of the host by the virtual machines. One example of the hypervisor 224 that may be used in an embodiment described herein is a VMware ESXi™ hypervisor provided as part of the VMware vSphere® solution made commercially available from VMware, Inc. The hypervisor 224 may run on top of the operating system of the host or directly on hardware components of the host. For other types of virtual computing instances, the host may include other virtualization software platforms to support those virtual computing instances, such as Docker virtualization platform to support “containers.” In the following description, the virtual computing instances 208 will be described as being virtual machines.

In the illustrated embodiment, the hypervisor 224 includes a logical network (LN) agent 226, which operates to provide logical networking capabilities, also referred to as “software-defined networking” (SDN). Each logical network may include software managed and implemented network services, such as bridging. L3 routing, L2 switching, network address translation (NAT), and firewall capabilities, to support one or more logical overlay networks in the SDDC 200. The logical network agent 226 receives configuration information from a logical network manager 228 (which may include a control plane cluster) and, based on this information, populates forwarding, firewall and/or other action tables for dropping or directing packets between the virtual machines 208 in the host 210, other virtual machines on other hosts, and/or other devices outside of the SDDC 200. Collectively, the logical network agent 226, together with other logical network agents on other hosts, according to their forwarding/routing tables, implement isolated overlay networks that can connect arbitrarily selected virtual machines with each other. Each virtual machine may be arbitrarily assigned a particular logical network in a manner that decouples the overlay network topology from the underlying physical network. Generally, this is achieved by encapsulating packets at a source host and decapsulating packets at a destination host so that virtual machines on the source and destination can communicate without regard to underlying physical network topology. In a particular implementation, the logical network agent 226 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols such as stateless transport tunneling (STT), Network Virtualization using Generic Routing Encapsulation (NVGRE), or Geneve, instead of, or in addition to, VXLAN.

The SDDC 200 also includes a virtualization manager 230 that communicates with the hosts 210 via a management network 232. In an embodiment, the virtualization manager 230 is a computer program that resides and executes in a computer system, such as one of the hosts, or in a virtual computing instance, such as one of the virtual machines 208 running on the hosts. One example of the virtualization manager 230 is the VMware vCenter Server® product made available from VMware, Inc. In an embodiment, the virtualization manager is configured to carry out administrative tasks for a cluster of hosts that forms an SDDC, including managing the hosts in the cluster, managing the virtual machines running within each host in the cluster, provisioning virtual machines, migrating virtual machines from one host to another host, and load balancing between the hosts in the cluster.

As noted above, the SDDC 200 also includes the logical network manager 228 (which may include a control plane cluster), which operates with the logical network agents 226 in the hosts 210 to manage and control logical overlay networks in the SDDC 200. Logical overlay networks comprise logical network devices and connections that are mapped to physical networking resources, e.g., switches and routers, in a manner analogous to the manner in which other physical resources as compute and storage are virtualized. In an embodiment, the logical network manager 228 has access to information regarding physical components and logical overlay network components in the SDDC. With the physical and logical overlay network information, the logical network manager 228 is able to map logical network configurations to the physical network components that convey, route, and filter physical traffic in the SDDC 200. In one particular implementation, the logical network manager 228 is a VMware NSX® product running on any computer, such as one of the hosts or a virtual machine in the SDDC 200.

The SDDC 200 also includes a gateway 234 to control network traffic into and out of the SDDC 200. In an embodiment, the gateway 234 may be implemented in one of the virtual machines 208 running in the SDDC 200. In a particular implementation, the gateway 234 may be an edge services gateway. One example of the edge services gateway 234 is VMware NSX® Edge™ product made available from VMware, Inc.

As noted above, the SDDC 200 also includes the transport client 108, which works with the transport service 106 to provide connectivity for the cloud-based service 104 to communicate with a target resource in the SDDC 200, such as the virtualization manager 230. In some embodiments, the SDDC 200 may include more than one transport client. The transport client 108 will be described in more detail below.

Turning back to FIG. 1, as noted above, the cloud-based service 104 of the distributed computing system 100 is configured or programmed to access the SDDCs 102 to execute various operations. As an example, the cloud-based service 104 may be configured or programmed to deploy, update, delete and otherwise manage components in the SDDCs 102. The cloud-based service 104 may also be configured or programmed to manage allocation of virtual computing resources to the SDDCs 102. In an embodiment, the cloud-based service 104 may be configured or programmed to be accessible to authorized users via a REST (Representational State Transfer) API (Application Programming Interface) or any other client-server communication protocol so that various operations can be executed at the SDDCs 102. As an example, the cloud-based service 104 may be a VMware vCloud Director® service from VMware, Inc., which may be running on VMware cloud (VMC) on Amazon Web Services (AWS).

The transport service 106 of the distributed computing system 100 is configured or programmed to connect the cloud-based service 104, as a reverse proxy client, to the SDDCs 102. In order to provide connectivity for the cloud-based service 104 to more than one of the SDDCs 102, the transport service 106 includes a cluster of transport server nodes 110. Each of these transport server nodes 110 can establish a communication connection with one of the SDDCs 102 via the transport client 108 running on that SDDC in a server-client relationship. In addition, each of these transport server nodes 110 can handle a connection request from the cloud-based service 104 to access a target resource in a particular SDDC. If the transport server node handling the connection request has an established communication channel with the particular SDDC, connectivity between the cloud-based service to the particular SDDC can be made through that transport server node. However, if the transport server node handling the connection request does not have an established communication channel with the particular SDDC, that transport server node cannot provide connectivity between the cloud-based service to the particular SDDC through that transport server node. Rather, the transport server node that has an established communication channel with the particular SDDC must be found and selected so that connectivity between the cloud-based service to the particular SDDC can be made through the transport server node handling the request and the transport server node that has an established communication channel with the particular SDDC.

The selection of a transport server node from the available transport server nodes 110 in the transport service 106 to establish a communication channel with a particular SDDC 102 is made by a load balancer 112 running in the transport service. In addition, the selection of a transport server node from the available transport server nodes in the transport service in response to a connection request from the cloud-based service 104 for a target resource in a particular SDDC is also made by the load balancer. In an embodiment, these transport server node selections are made by the load balancer in random or without regards to any established communication channels or connections with the transport clients 108 in the SDDCs so that the various connection requests are distributed among the available transport server nodes 110 in the transport service 106. In an embodiment, the transport server nodes may be implemented as a high performance computing (HPC) cluster. In some embodiments, the transport server nodes may be implemented as Kubernetes pods in a Kubernetes system running on a public cloud.

In an embodiment, the transport server nodes 110 in the transport service 106 are stateless server nodes. Thus, no information regarding the transport server nodes 110 is persistently stored on any non-volatile memory. As an example, information regarding any established communication channels between the transport server nodes 110 and the transport clients 108 in the SDDCs 102 is not persistently stored. In addition, information regarding the transport server nodes handling connection requests from the cloud-based service 104 is also not persistently stored. Also, information regarding connectivity paths (including any jumps between the transport server nodes) through the transport server nodes is not persistently stored.

However, as shown in FIG. 1, a shared state 114 is maintained in the transport service 106 in volatile memory. The shared state 114 may include various information related to connections between the cloud-based service 104 and the SDDCs 102. The shared state 114 includes, but not limited to, one or more supported target sets, each of which is a list of hostnames for a particular network name, and one or more data channel sets, each of which is a list of hostname for a particular data channel identification (ID). The supported target set and the data channel set are described in more detail below. In an embodiment, the framework of the transport service 106 may be provided using Hazelcast technology.

As described in more detail below, in order for the cloud-based service 104 to have a connection with a particular SDDC 102 in the distributed computing system 100 to communicate with a target resource in the particular SDDC, a command channel is first established between a transport client 108 in the particular SDDC and one of the transport server nodes 110 in the transport service 106, which is determined by the load balancer 112 in the transport service. When a connection request to the particular SDDC 102 is requested by the cloud-based service 104 to the transport service 106, a connection between the cloud-based service to the transport client 108 in the particular SDDC is made through at least one of the transport server nodes 110 in the transport service, which is determined by the load balancer 112 in the transport service. If the connection request is handled by a transport server node that has an established command channel with the transport client 108 in the particular SDDC 102, then the connection is made from the cloud-based service 104 to that transport client through only that transport server node. However, if the connection request is handled by a transport server node that does not have an established command channel with the transport client in the particular SDDC, then the connection is made from the cloud-based service to that transport client through the transport server node that is handling the connection request and the transport server node that has an established command channel with that transport client. In some embodiments, in addition to the command channel, a data channel is similarly established between the cloud-based service 104 and the transport client in the particular SDDC.

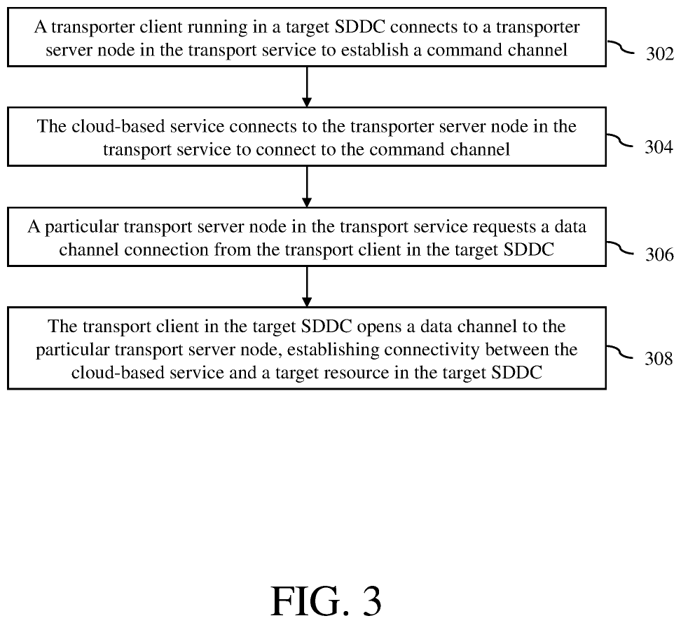

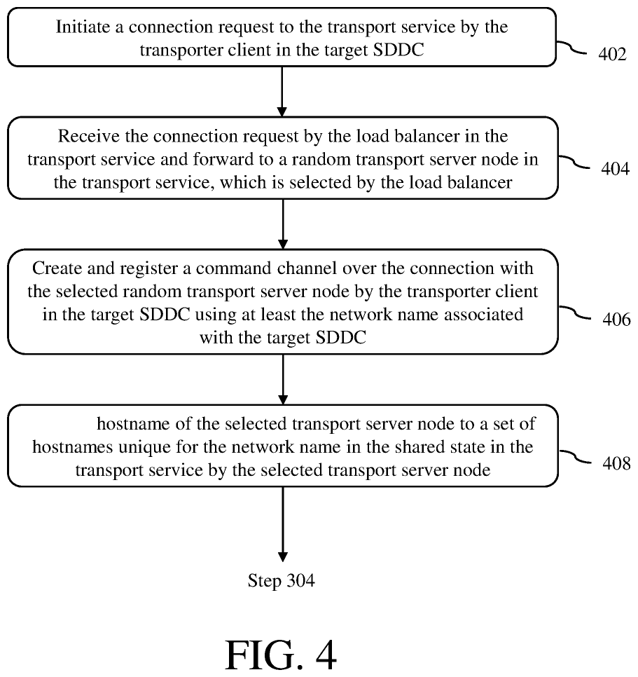

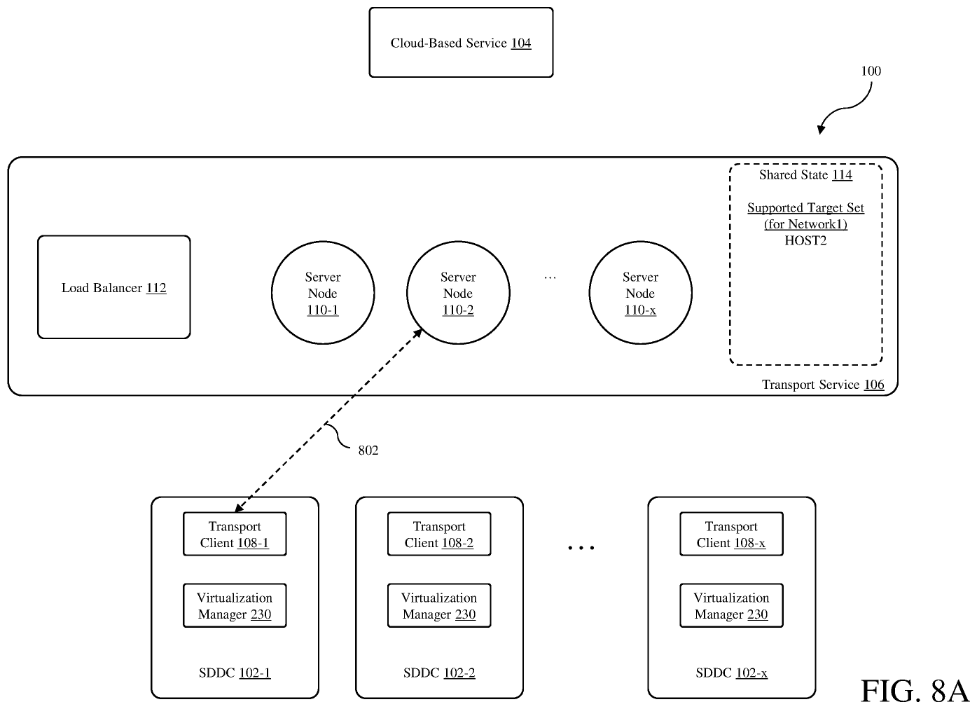

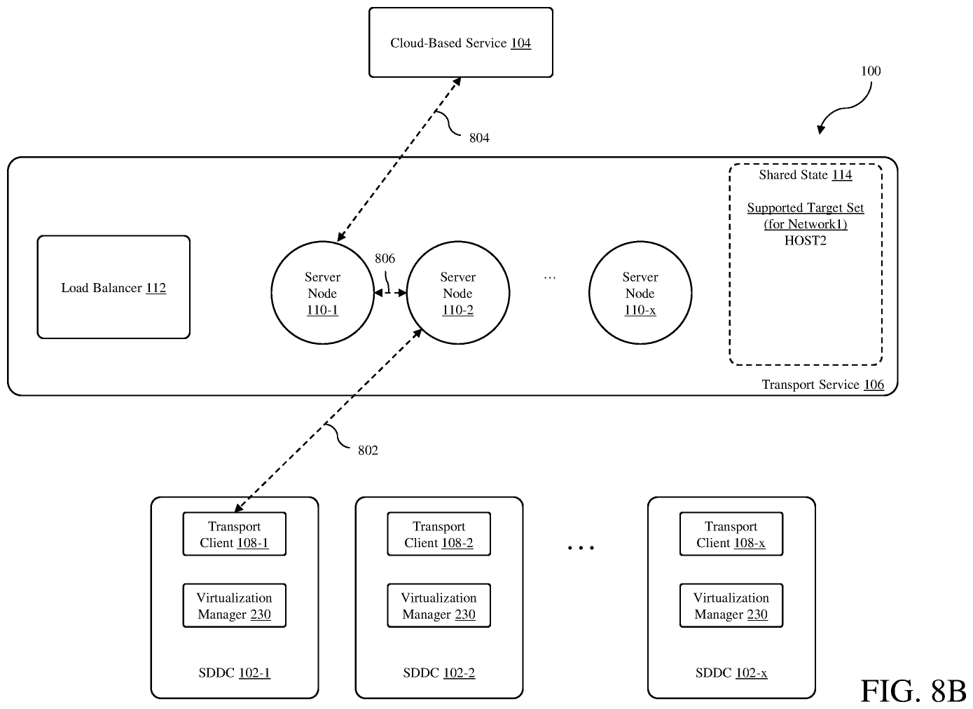

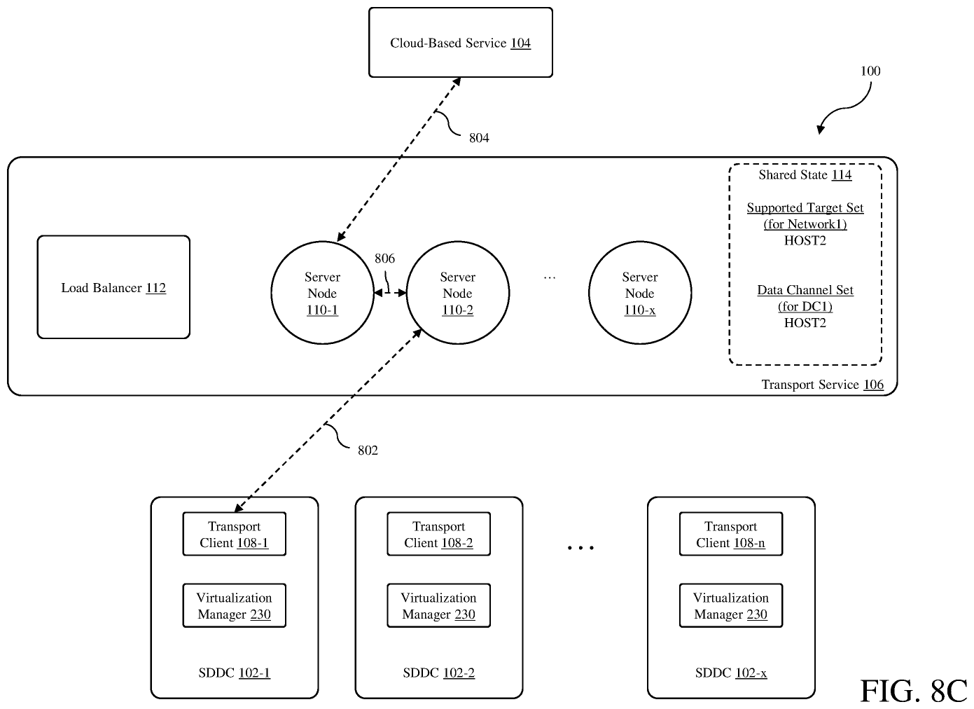

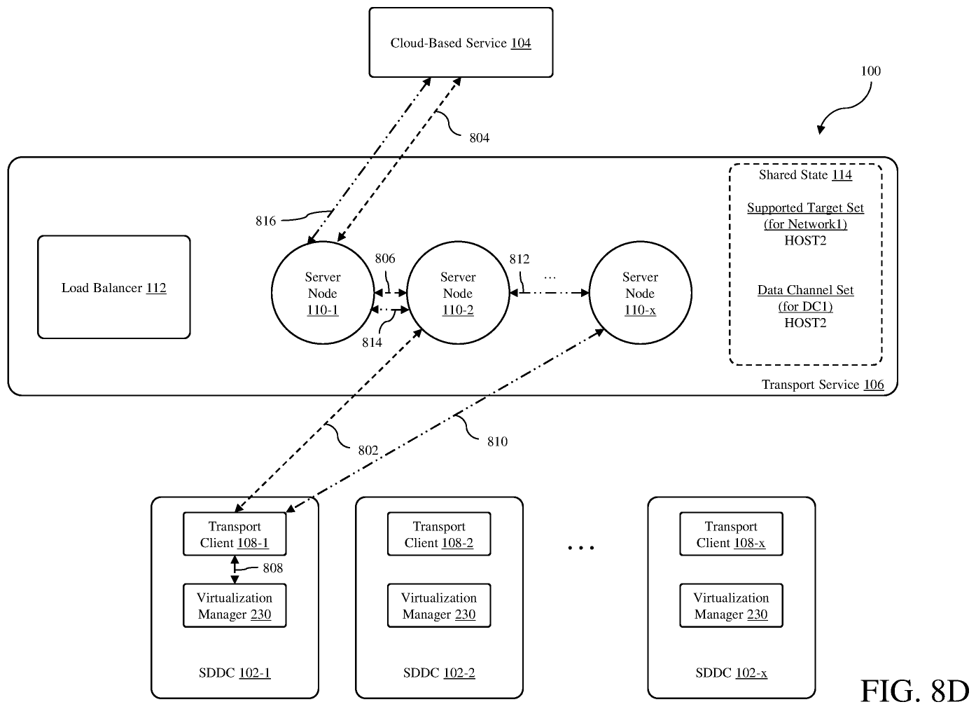

A process of establishing a connection between the cloud-based service 104 and a target resource in one of the SDDCs 102 (“a target SDDC”) in the distributed computing system 100 in accordance with an embodiment of the invention is described with reference to a process flow diagram shown in FIG. 3 using an example illustrated in FIGS. 8A-8D. The process begins at step 302, where a transport client 108 running in the target SDDC 102 connects to a transport server node 110 in the transport service 106 to establish a command channel. In an embodiment, this step is automatically executed when the transport client 108 in the target SDDC 102 first starts to operate or run, which may be immediately after that transport client is installed in the target SDDC. This step is described in detail in FIG. 4, which shows substeps of step 302.

As shown in FIG. 4, at substep 402, a connection request to the transport service 106 is initiated by the transport client 108 in the target SDDC 102. Next, at substep 404, the connection request is received by the load balancer 112 in the transport service 106 and forwarded to a random transport server node 110 in the transport service, which is selected or decided by the load balancer. Next, at substep 406, a command channel over the connection with the selected random transport server node 110 is created and registered by the transport client 108 in the target SDDC 102 using at least the network name associated with or assigned to the target SDDC. In other embodiments, a different identifier or name may be used to associate the command channel to the target SDDC 102. Next, at substep 408, the hostname of the selected transport server node 110 is added to a set of hostnames unique for the network name in the shared state 114 in the transport service 106 by the selected transport server node. This set of hostnames will be referred to herein as the supported target set. In other embodiments, a different name or identifier may be used for the selected transport server node 110. This newly created command channel will remain active on the selected transport server node 110 in the transport service 106.

These substeps 402-408 of step 302 are illustrated using the example depicted in FIG. 8A, which individually identifies the transport server nodes 110 in the transport service as transport server nodes 110-1, 110-2 . . . 110-x, the SDDCs 102 as SDDCs 102-1, 102-2 . . . 102-x, and the transport clients 108 in the SDDCs as transport clients 108-1, 108-2 . . . 108-x. In FIG. 8A, only the transport client 108 and the management server 230 are shown in each of the SDDCs 102-1, 102-2 . . . 102-x. As shown in FIG. 8A, a command channel 802 has been established between the transport client 108-1 in the SDDC 102-1, which initiated a connection request to establish the command channel, and the transport server node 110-2 in the transport service 106, which was selected by the load balancer 112 when the connection request was received at the transport service 106. FIG. 8A also shows the shared state 114 of the transport service 106, which now includes “HOST2”, which is the hostname of the transport server node 110-2, in the supported target set for the network name “Network1”, which is the network name associated with the transport client 108-1 in the SDDC 102-1.

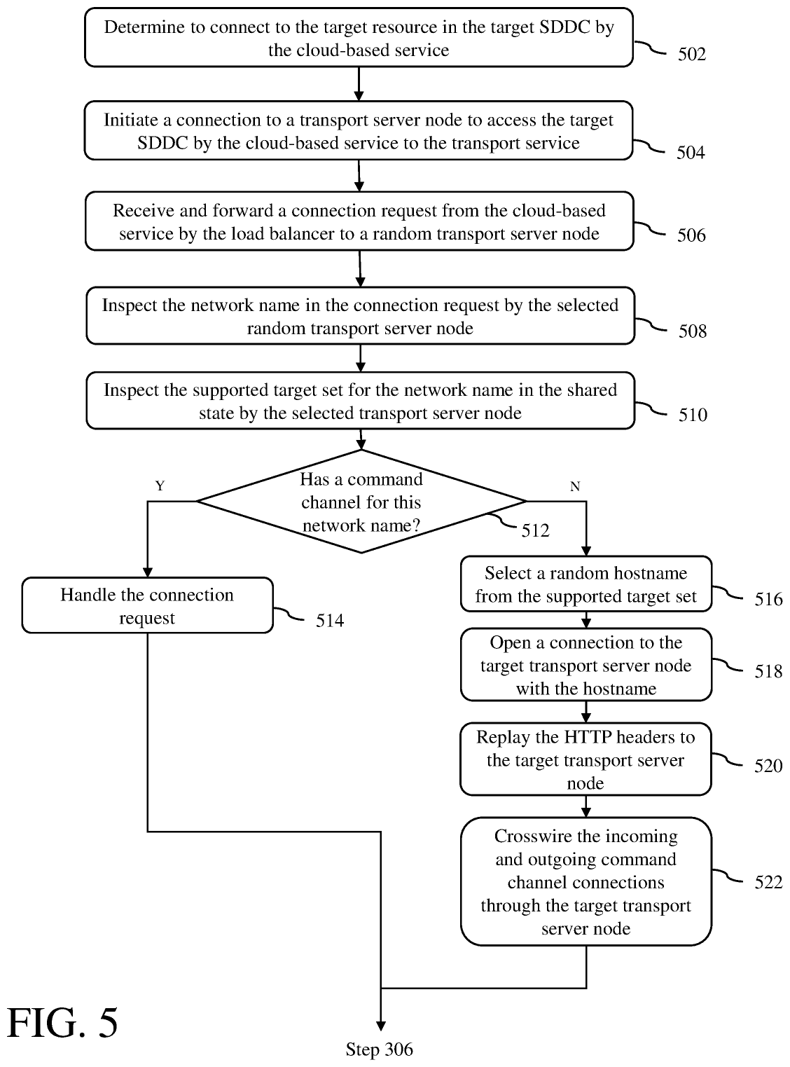

Turning back to the process flow diagram of FIG. 3, after the transport client 108 in the target SDDC 102 has connected to the selected transport server node 110, the process proceeds to step 304, where a proxy client, i.e., the cloud-based service 104 in this embodiment, connects to a transport server node 110 to connect to the command channel. This step is described in detail in FIG. 5, which shows the substeps of step 304, using the cloud-based service 104 as the proxy client.

As shown in FIG. 5, at substep 502, a determination is made by the cloud-based service 104 to connect to the target resource in the target SDDC 102. This determination may be made as part of an operation, such as registering the SDDC for management by a VMware vCloud Director® deployment running in the cloud-based service. This ongoing relationship involves vCloud director component using connectivity for provisioning SDDC resources, configuring SDDC resources, managing SDDC lifecycles and transferring resources, such as disk images from cloud-based storage to the SDDC. Next, at substep 504, a connection to a transport server node 110 to access the target SDDC 102 is initiated or requested by the cloud-based service 104 to the transport service 106. The transport server node may appear to be a Hypertext Transfer Protocol (HTTP) proxy to the cloud-based service 104. Thus, the connection request can be viewed as a proxy request. In an embodiment, the connection request includes the network name, e.g., in the header of the request. Next, at substep 506, a connection request from the cloud-based service 104 is received by the load balancer 112 in the transport service 106 and forwarded to a random transport server node 110 in the transport service 106, which is randomly selected by the load balancer.

Next, at substep 508, the network name in the connection request is inspected or examined by the selected random transport server node 110. Next, at substep 510, the supported target set for the network name in the shared state 114 is inspected or examined by the selected transport server node 110. Next, at substep 512, a determination is made by the selected transport server node 110 whether the selected transport server node has an established command channel for this network name. That is, a determination is made whether the connection request has been forwarded to the transport server node with a command channel for this network name, and thus, a command channel to the transport client 108 in the target SDDC 102.

If the selected transport server node 110 has a command channel for the network name, the connection request is handled by that selected transport server node, at substep 514. However, if the selected transport server node does not have a command channel for the network name, then the process proceeds to substep 516.

At substep 516, a random hostname is picked or selected from the supported target set in the shared state 114 by the selected transport server node 110. Next, at substep 518, a connection to the target transport server node with the hostname is opened by the selected transport server node. Next, at substep 520, the HTTP headers are replayed to the target transport server node by the selected transport server node. Next, at substep 522, the incoming and outgoing command channel connections are crosswired through the target transport server node by the selected transport server node. Thus, the target transport server node will process the connection request as if it has received the connection request from the cloud-based service 106. However, by definition, the target transport server node will be the node with a command channel for the network name.

These substeps 502-522 of step 304 are illustrated using the example depicted in FIG. 8B, which shows that the transport server node 110-1 in the transport service 106 has been selected for a request for a connection 804 from the cloud-based service 104 for the target resource in the target SDDC 102. In this example, the selected transport server node 110-1 does not have the command channel 802 to the transport client 108-1 in the target SDDC 102-1. Thus, the transport server node 110-2 from the supported target set in the shared state 114 is selected, and incoming and outgoing connections to and from the cloud-based service 104 are crosswired so that the connections go through the transport server node 110-2, as illustrated by the arrow 806. Therefore, the established command channel connection includes the connections 802, 804 and 806.

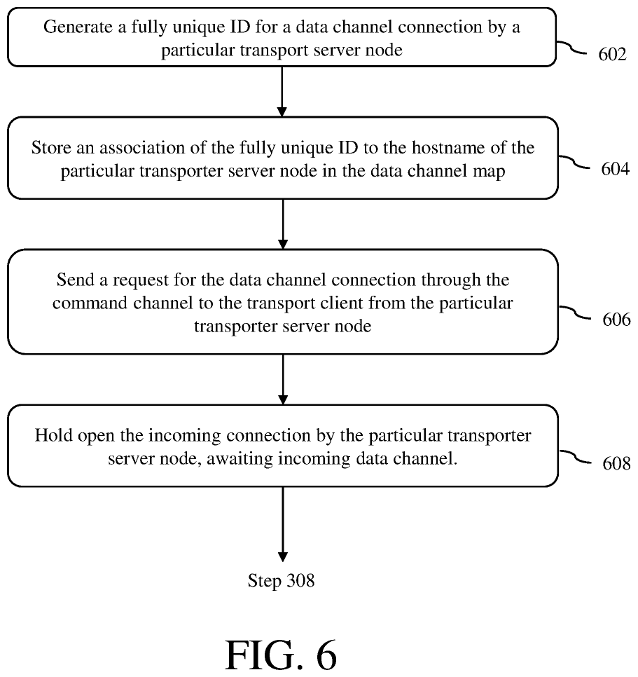

Turning back to the process flow diagram of FIG. 3, after the cloud-based service 104 has connected to the transport server node 110 with the command channel to the transport client 108 in the target SDDC 102, the process proceeds to step 306, where a particular transport server node 110 in the transport service 106 requests a data channel connection from the transport client 108 in the target SDDC 102. The data channel connection is optional. In some embodiments, the data channel connection may be eliminated from the process by running a virtual private network (VPN) over the transport client to randomly selected transport server nodes connection. In other embodiments, rather than creating data channel connections, virtual data channels may be multiplexed over the initial connection. The step 306 is described in detail in FIG. 6, which shows the substeps of step 306.

As shown in FIG. 6, at substep 602, a fully unique identification (ID) for a data channel connection is generated by a particular transport server node 110 in the transport service 106. Next, at substep 604, an association of the fully unique ID to the hostname of the particular transport server node 110 is stored in the data channel map in the shared state 114 by the particular transport server node. Next, at substep 606, a request for the data channel connection is sent through the command channel to the transport client 108 in the target SDDC 102 from the particular transport server node 110. Next, at substep 608, the incoming connection is held open by the particular transport server node 110, awaiting incoming data channel.

These substeps 602-608 of step 306 are illustrated using the example depicted in FIG. 8C, which shows that a fully unique ID “DC1” for a data channel connection has been associated with the name “HOST2” of the particular transport server node 110-2 in the data channel map in the shared state 114. In FIG. 8C, the particular transport client 110-2 has received the data channel connection request, and the transport server node 110-2 is waiting for incoming data channel.

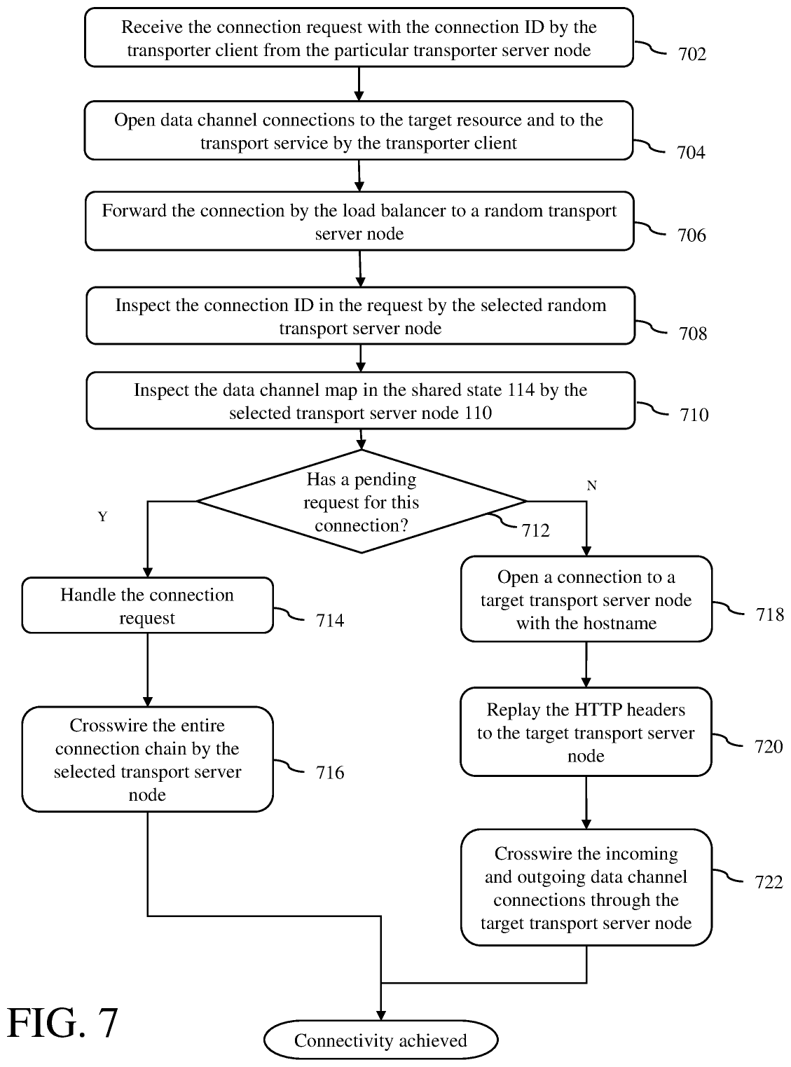

Turning back to the process flow diagram of FIG. 3, after the particular transport server node 110 has requested the connection from the transport client 108 in the target SDDC 102, the process proceeds to step 308, where the transport client 108 in the target SDDC 102 opens a data channel to the particular transport server node 110, establishing connectivity between the cloud-based service 104 and the target resource in the target SDDC 102. This step is described in detail in FIG. 7, which shows the substeps of step 308.

As shown in FIG. 7, at substep 702, the connection request with the connection ID is received by the transport client 108 in the target SDDC 102 from the particular transport server node 110. Next, at substep 704, two data channel connections are opened by the transport client 108 in the target SDDC 102. The first data channel connection is to the target resource, e.g., the virtualization manager 230 in the target SDDC 102, from the transport client 108 in the target SDDC 102. The second data channel connection is to the transport service 106 from the transport client 108 in the target SDDC 102. Next, at substep 706, the connection to the transport service 106 is forwarded by the load balancer 112 to a random transport server node 110 in the transport service 106, which is randomly selected by the load balancer 112.

Next, at substep 708, the connection ID in the request, e.g., in HTTP headers, is inspected or examined by the selected random transport server node 110. Next, at substep 710, the data channel map in the shared state 114 is inspected or examined by the selected transport server node 110. Next, at substep 712, a determination is made by the selected transport server node 110 whether the selected transport server node has a pending request for this connection. That is, a determination is made whether the connection request has been forwarded to the transport server node with the pending request for this connection or to another transport server node without the pending request for this connection.

If the selected transport server node 110 has the pending request for the connection, the connection request is handled by that selected transport server node, at substep 714. In other words, no forwarding to another transport server node 110 in the transport service 106 is performed. Next, at substep 716, the entire connection chain is crosswired together by the selected transport server node, achieving connectivity between the cloud-based service 104 and the target resource, e.g., the virtualization manager 230 in the target SDDC 102.

However, if the selected transport server node 110 does not have the pending request for the connection, then the process proceeds to substep 718, where a connection to a target transport server node with the hostname associated with the data channel ID is opened by the selected transport server node. The target transport server node may be the particular transport server node. Next, at substep 720, the HTTP headers are replayed to the target transport server node. Next, at substep 722, the incoming and outgoing data channel connections are crosswired through the target transport server node by the selected transport server node, achieving connectivity between the cloud-based service 104 and the target resource, e.g., the virtualization manager 230 in the target SDDC 102. The target transport server node will process the connection request in the same way as if the target transport server node received the data channel connection request. However, by definition, the target transport server node would be the node with the pending connection.

These substeps 702-722 of step 308 are illustrated using the example depicted in FIG. 8D, which shows a data channel connection 808 from the transport client 108-1 in the SDDC 102-1 to the target resource, i.e., the virtualization manager 230. For a data connection 810 to the transport service 106 from the transport client 108-1 in the SDDC 102-1, the transport server node 110-x in the transport service 106 has been selected for a request for the data channel connection 808 from the transport client 108-1 in the target SDDC 102-1. In this example, the selected transport server node 110-x does not have the pending connection request. Thus, a data channel connection 812 to the transport server node 110-2 with the matching data channel ID has been opened and the incoming and outgoing data channel connections to and from the cloud-based service 104 are crosswired so that the connections go through the transport server node 110-2. As illustrated in FIG. 8D, the data channel connection includes the connections 808, 810, 812, 814 and 816.

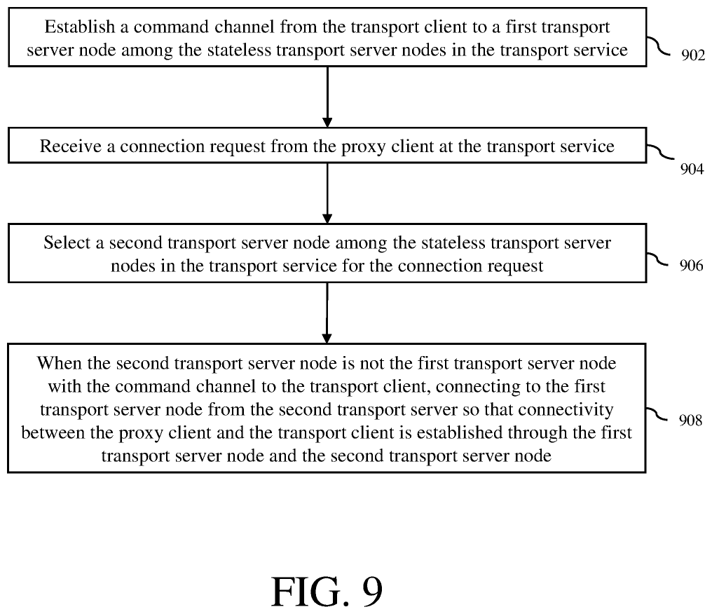

A computer-implemented method for connecting a proxy client to a transport client through a transport service with a plurality of stateless transport server nodes in a distributed computing system in accordance with an embodiment of the invention is described with reference to a process flow diagram of FIG. 9. At block 902, a command channel is established from the transport client to a first transport server node among the stateless transport server nodes in the transport service. At block 904, a connection request from the proxy client is received at the transport service. At block 906, a second transport server node is selected among the stateless transport server nodes in the transport service for the connection request. At block 908, when the second transport server node is not the first transport server node with the command channel to the transport client, the first transport server node is connected from the second transport server so that connectivity between the proxy client and the transport client is established through the first transport server node and the second transport server node.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer usable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for connecting a proxy client to a transport client through a transport service with a plurality of stateless transport server nodes in a distributed computing system, the method comprising:
establishing a command channel from the transport client to a first transport server node among the stateless transport server nodes in the transport service;
receiving a connection request from the proxy client at the transport service;
selecting a second transport server node from the stateless transport server nodes in the transport service for the connection request; and
when the second transport server node is not the first transport server node with the command channel to the transport client, connecting to the first transport server node from the second transport server so that connectivity between the proxy client and the transport client is established through the first transport server node and the second transport server node.

2. The computer-implemented method of claim 1, wherein the selecting the second transport server node includes randomly selecting the second transport server node among the stateless transport server nodes in the transport service for the connection request by a load balancer.

3. The computer-implemented method of claim 1, further comprising:
adding an identifier of the first transport server node to a supported target set in a shared state for a name associated with the transport client when the command channel is established from the transport client to the first transport server node; and
selecting the identifier of the first transport server node for the name associated with the transport client in the supported target set to connect to the first transport server node from the second transport server.

4. The computer-implemented method of claim 3, wherein the identifier of the first transport server node is a hostname of the first transport server node.

5. The computer-implemented method of claim 1, further comprising:
sending a request for a data channel from a third transport server node to the transport client;
in response to the request, opening a data channel connection from the transport client to the transport service;
selecting a fourth transport server node from the stateless transport server nodes in the transport service for the data channel connection; and
when the fourth transport server node is not the third transport server node with a pending request for the data channel, connecting to the third transport server node from the fourth transport server so that the data channel connection between the proxy client and the transport client is established through the third transport server node and the fourth transport server node.

6. The computer-implemented method of claim 5, further comprising:
adding an identifier of the third transport server node for the data channel to a data channel set in a shared state; and
selecting the identifier of the third transport server node for the data channel in the data channel set to connect to the third transport server node from the fourth transport server node.

7. The computer-implemented method of claim 1, wherein the proxy client is a service running in a public cloud computing environment and the transport client is running in a software-defined data center.

8. The computer-implemented method of claim 1, wherein the stateless transport server nodes are Kubernetes pods.

9. A non-transitory computer-readable storage medium containing program instructions for connecting a proxy client to a transport client through a transport service with a plurality of stateless transport server nodes in a distributed computing system, wherein execution of the program instructions by one or more processors causes the one or more processors to perform steps comprising:
establishing a command channel from the transport client to a first transport server node among the stateless transport server nodes in the transport service;
receiving a connection request from the proxy client at the transport service;
selecting a second transport server node from the stateless transport server nodes in the transport service for the connection request; and
when the second transport server node is not the first transport server node with the command channel to the transport client, connecting to the first transport server node from the second transport server so that connectivity between the proxy client and the transport client is established through the first transport server node and the second transport server node.

10. The non-transitory computer-readable storage medium of claim 9, wherein the selecting the second transport server node includes randomly selecting the second transport server node among the stateless transport server nodes in the transport service for the connection request by a load balancer.

11. The non-transitory computer-readable storage medium of claim 9, wherein the steps further comprise:
adding an identifier of the first transport server node to a supported target set in a shared state for a name associated with the transport client when the command channel is established from the transport client to the first transport server node; and
selecting the identifier of the first transport server node for the name associated with the transport client in the supported target set to connect to the first transport server node from the second transport server.

12. The non-transitory computer-readable storage medium of claim 10, wherein the identifier of the first transport server node is a hostname of the first transport server node.

13. The non-transitory computer-readable storage medium of claim 9, wherein the steps further comprise:
sending a request for a data channel from a third transport server node to the transport client;
in response to the request, opening a data channel connection from the transport client to the transport service;
selecting a fourth transport server node from the stateless transport server nodes in the transport service for the data channel connection; and
when the fourth transport server node is not the third transport server node with a pending request for the data channel, connecting to the third transport server node from the fourth transport server so that the data channel connection between the proxy client and the transport client is established through the third transport server node and the fourth transport server node.

14. The non-transitory computer-readable storage medium of claim 12, wherein the steps further comprise:
adding an identifier of the third transport server node for the data channel to a data channel set in a shared state; and
selecting the identifier of the third transport server node for the data channel in the data channel set to connect to the third transport server node from the fourth transport server node.

15. The non-transitory computer-readable storage medium of claim 9, wherein the proxy client is a service running in a public cloud computing environment and the transport client is running in a software-defined data center.

16. The non-transitory computer-readable storage medium of claim 9, wherein the stateless transport server nodes are Kubernetes pods.

17. A system comprising:
memory; and
at least one processor configured to:
establish a command channel from a transport client to a first transport server node among stateless transport server nodes in a transport service;
receive a connection request from a proxy client at the transport service;
select a second transport server node from the stateless transport server nodes in the transport service for the connection request; and
when the second transport server node is not the first transport server node with the command channel to the transport client, connect to the first transport server node from the second transport server so that connectivity between the proxy client and the transport client is established through the first transport server node and the second transport server node.

18. The system of claim 17, wherein the at least one processor is configured to:
add an identifier of the first transport server node to a supported target set in a shared state for a name associated with the transport client when the command channel is established from the transport client to the first transport server node; and
select the identifier of the first transport server node for the name associated with the transport client in the supported target set to connect to the first transport server node from the second transport server.

19. The system of claim 17, wherein the at least one processor is configured to:
send a request for a data channel from a third transport server node to the transport client;
in response to the request, open a data channel connection from the transport client to the transport service;
select a fourth transport server node from the stateless transport server nodes in the transport service for the data channel connection; and
when the fourth transport server node is not the third transport server node with a pending request for the data channel, connect to the third transport server node from the fourth transport server so that the data channel connection between the proxy client and the transport client is established through the third transport server node and the fourth transport server node.

20. The system of claim 19, wherein the at least one processor is configured to:
add an identifier of the third transport server node for the data channel to a data channel set in a shared state; and
select the identifier of the third transport server node for the data channel in the data channel set to connect to the third transport server node from the fourth transport server node.
